(19) United States
(12) Patent Application Publication
(10) Pub. No.: US 2010/0066482 A1
(43) Pub. Date: Mar. 18, 2010

(54) ELECTRONIC COMPONENT WITH LEAD WIRE

(75) Inventors: Masamichi SHIKO, Yasu-shi (JP); Shingo OKUYAMA, Yasu-shi (JP); Yuichi SHINOMIYA, Konan-shi (JP); Hideyuki SHIRAKI, Ritto-shi (JP); Kazuo MIYAKE, Otsu-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: Murata Manufacturing Co., Ltd., Nagaokakyo-shi (JP)

(21) Appl. No.: 12/540,444

(22) Filed: Aug. 13, 2009

(30) Foreign Application Priority Data
Sep. 16, 2008 (JP) 2008-236460

(51) Int. Cl. H01C 7/00

(52) U.S. Cl. 338/22 R

(57) ABSTRACT

In an electronic component, first and second lead wires include coated portions and first and second metal wire exposed portions. The coated portions include metal wires that are coated with insulating members. Each of the first and second metal wire exposed portions have a flat shape. The first lead wire and the second lead wire are arranged parallel or substantially parallel to each other. The second lead wire is shorter than the first lead wire. The first metal wire exposed portion is soldered to the side surface folded portion of the terminal electrode. The second metal wire exposed portion is soldered to the side surface folded portion of the terminal electrode. The first and second metal wire exposed portions are located substantially in the same plane. A solder fillet is provided not only on the side surface folded portions, but also on end surface portions and in a gap.

### BACKGROUND OF THE INVENTION

1. Field of the Invention

The present invention relates to an electronic component with lead wire and, more particularly, to an electronic component including a lead wire in which an electronic component, such as a thermistor, is arranged at a portion spaced away from a control board on which the electronic component is mounted.

2. Description of the Related Art

A personal computer, a power-assisted bicycle, and other devices may use a relatively large secondary battery or may use a plurality of fuel cells arranged in parallel. For example, there may be a situation in which a portion of a secondary battery at which the temperature must be measured needs to be spaced from a control board on which a thermistor, which defines a temperature sensor, is mounted. Therefore, a thermistor including a relatively long lead wire is used. That is, by using a temperature sensor including the lead wire, the lead wire may be fixedly soldered on the control board, such as a printed circuit board, while a temperature sensing portion of the thermistor may be arranged adjacent to a component of which the temperature needs to be detected. Thus, it is possible to accurately detect the temperature of a target portion.

For example, Japanese Unexamined Patent Application Publication No. 10-149903 discloses, as shown in FIG. 14, a thermistor element that includes a single-plate thermistor 103 in which electrode layers 102a and 102b are respectively provided on both principal surfaces of a plate-shaped thermistor body 101, wherein the thermistor 103 is supported by lead wires 105a and 105b, a heat-resistant conductive paste 104 including a glass frit is applied at each of the distal ends of the lead wires 105a and 105b, insulating inorganic substance layers 106 are respectively provided on the surfaces of the thermistor element 101, inserted in a glass tube 107 so as to cover a joint and then glass-encapsulated at the same time with baking the electrodes.

In addition, Japanese Unexamined Patent Application Publication No. 11-108771 discloses, as shown in FIG. 15, a thermistor temperature sensor in which, between a pair of lead wires 112a and 112b extending from a thermistor 111, one lead wire 112a is arranged in a U-shape, parallel arranged insulation coating lead wires 113a and 113b are connected to the thermistor 111 via solder members 114a and 114b, and then the thermistor 111, the solder members 114a and 114b and distal end portions of the insulation coating lead wires 113a and 113b are accommodated in a heat-shrinkable insulating material 115, such as poly-olefin resin.

In Japanese Unexamined Patent Application Publication No. 11-108771, the solder members 114a and 114b are designed to be spaced apart at a certain distance (for example, about 5 mm to about 10 mm) from each other in the longitudinal direction so as not to contact each other.

When the structure in which the plate-shaped thermistor 103 is supported by the pair of lead wires 105a and 105b as described in Japanese Unexamined Patent Application Publication No. 10-149903 is used, as thermal stress becomes excessive, the insulating member that coats the metal wire thermally expands, and a stress is generated in a direction in which the lead wires 105a and 105b expand because of a difference in thermal expansion between the lead wires 105a and 105b and the glass tube. That is, as thermal stress becomes excessive, the lead wires 105a and 105b generate a stress in a direction in which the lead wires 105a and 105b are pulled outward as indicated by the arrows a. Thus, a mechanical stress occurs in the electrode layers 102a and 102b in a direction away from the thermistor body 101 as indicated by the arrows b. Furthermore, the glass tube may break.

Particularly, when the lead wire 105a and the lead wire 105b have different lengths or when there is a difference in temperature between the lead wire 105a and the lead wire 105b, the amount of thermal expansion also differs therebetween. Thus, a stress occurs in the electrode layers 102a and 102b in the directions of arrow b.

As a result, there is a problem in that a portion of the electrode layers 102a and 102b peel off from the thermistor body 101 which increases the resistance value and, therefore, a measurement error occurs with respect to an actual temperature. In addition, as an excessive thermal stress is applied, the above described stress in the directions of arrows a and b occurs. As a result, the thermistor body 101 itself breaks and may cause a decrease in reliability.

In addition, because the thermistor 103 is supported by the lead wires 105a and 105b, the size in the width direction is regulated by the thickness of the thermistor. For this reason, a distance between the electrodes is further reduced, and a short-circuit is likely to occur. Therefore, there is also a problem in that it is difficult to further reduce the size.

On the other hand, in Japanese Unexamined Patent Application Publication No. 11-108771, because the thermistor 111 is arranged such that the longitudinal direction of the thermistor 111 is parallel to the insulation coating lead wire 113b, it is presumed that almost no stress occurs in the direction in which the electrodes separate.

However, in Japanese Unexamined Patent Application Publication No. 11-108771, the solder members 114a and 114b are spaced apart at a certain distance from each other in the longitudinal direction so that the solder members 114a and 114b do not contact each other. Because the lead wires 112a and 112b are arranged parallel to the longitudinal direction of the thermistor 111, when an impact or other external force is applied from the outside, the solder members 114a and 114b may peel off. Furthermore, a stress concentrates on the joints between the lead wires 112a and 112b and the thermistor 111, and, therefore, there is a possibility that the electrical connection may be unstable. Thus, in Japanese Unexamined Patent Application Publication No. 11-108771, it is necessary to coat the thermistor 111, the lead wires 112a and 112b, and other elements with the heat-shrinkable insulating material 115. That is, in the configuration described in Japanese Unexamined Patent Application Publication No. 11-108771, it is necessary to coat a large spatial region from the thermistor 111 to the lead wires 112a and 112b with the heat-shrinkable insulating material 115.

However, the insulating resin that defines the heat-shrinkable insulating material 115 has relatively low thermal conductivity. Therefore, if these regions are coated with the heat-shrinkable insulating material 115, detection sensitivity decreases as compared to when no heat-shrinkable insulating material 115 is provided.

### SUMMARY OF THE INVENTION

To overcome the problems described above, preferred embodiments of the present invention provide an electronic component including a lead wire, which has improved bonding strength with a simple structure and low cost and which has improved electrical connection and high reliability.

According to a preferred embodiment of the invention, an electronic component includes a component body and terminal electrodes, each of which has an end surface portion and a side surface folded portion and is arranged on each side of the component body, and first and second lead wires that are electrically connected to the terminal electrodes, wherein each of the first and second lead wires includes a coated portion in which a metal wire is coated with an insulating member, and first and second metal wire exposed portions that have a flat shape or a substantially flat shape and that are electrically connected to the terminal electrodes, the first lead wire and the second lead wire are arranged parallel or substantially parallel to each other, the second lead wire is shorter than the first lead wire, and the first metal wire exposed portion is bonded to the side surface folded portion of one of the terminal electrodes via solder, while the second metal wire exposed portion is bonded to the side surface folded portion of the other one of the terminal electrodes via solder.

Preferably, the first and second lead wires are arranged so that the side surface folded portion of the one of the terminal electrodes to which the first metal wire exposed portion is bonded and the side surface folded portion of the other one of the terminal electrodes to which the second metal wire exposed portion is bonded are disposed substantially in the same plane.

Preferably, the first and second lead wires are arranged such that a surface of the side surface folded portion of the one of the terminal electrodes to which the first metal wire exposed portion is bonded and a surface of the side surface folded portion of the other one of the terminal electrodes to which the second metal wire exposed portion is bonded are arranged substantially vertically with respect to each other.

Preferably, a solder fillet is provided on the side surface folded portion and end surface portion of the one of the terminal electrodes.

Preferably, the second metal wire exposed portion has a gap between a distal end of the coated portion and the end surface portion of the other one of the terminal electrodes, and a solder fillet is provided on the side surface folded portion and an end surface portion of the other one of the terminal electrodes and in the gap.

Preferably, the electronic component is inclined with respect to the first and second lead wires.

Preferably, the first and second metal wire exposed portions are bent to form an L-shape with respect to the corresponding coated portions.

Preferably, surfaces of the first and second metal wire exposed portions are roughened.

Preferably, each of the first and second metal wire exposed portions includes one of a through-hole, a closed-end hole, a cutout portion, a protrusion, a sawtooth portion, a curved portion, a dish portion, or a combination of any two or more of these, for example.

Preferably, the electronic component is a surface mount thermistor.

Preferably, the electronic component includes an internal electrode.

Preferably, a surface of the electronic component is coated with a glass layer.

Preferably, the first lead wire and the second lead wire are integrally bonded to each other in a longitudinal direction thereof to define a parallel lead wire set.

With the electronic component according to preferred embodiments of the present invention, the first and second lead wires each include a coated portion in which a metal wire is coated with an insulating member, and first and second metal wire exposed portions that have a flat shape or a substantially flat shape and that are electrically connected to the terminal electrodes, the first lead wire and the second lead wire are arranged parallel or substantially parallel to each other, the second lead wire is shorter than the first lead wire, and the first metal wire exposed portion is bonded to the side surface folded portion of one of the terminal electrodes via solder, while the second metal wire exposed portion is bonded to the side surface folded portion of the other one of the terminal electrodes via solder. Thus, the contact areas between the metal wires (core wires) and the side surface folded portions are increased. Thus, the bonding strength between the first and second lead wires and the terminal electrodes is improved, and, therefore, the reliability of the electrical connection is improved.

In addition, the first and second lead wires are arranged so that the side surface folded portion of the one of the terminal electrodes to which the first metal wire exposed portion is bonded and the side surface folded portion of the other one of the terminal electrodes to which the second metal wire exposed portion is bonded are located substantially in the same plane or surfaces of these side surface folded portions are arranged vertically or substantially vertically with respect to each other. Thus, even when a force is applied in directions causing the first lead wire and the second lead wire to move away from each other, those directions differ from a direction in which the first and second lead wires peel from the terminal electrodes. Therefore, it is possible to prevent peeling (electrode peeling) of the first and second lead wires from the terminal electrodes. Thus, it is possible to ensure the bonding between the first and second lead wires and the terminal electrodes at low cost with a simple structure. Therefore, it is possible to obtain a highly reliable electrical connection.

In addition, a solder fillet is provided on the side surface folded portion and end surface portion of the one of the terminal electrodes. Thus, even with a small chip electronic component, it is possible to ensure sufficient bonding strength. That is, in each of the terminal electrodes, the end surface portion is firmly fixed to the component body as compared with the side surface folded portion. Thus, by forming a solder fillet not only on the side surface folded portion but also on the end surface portion, it is possible to effectively prevent an electrode peeling.

In addition, the second metal wire exposed portion includes a gap between a distal end of the coated portion and the end surface portion of the other one of the terminal electrodes, and a solder fillet is provided on the side surface folded portion and end surface portion of the other one of the terminal electrodes and in the gap. Thus, it is possible to increase the region in which the solder fillet is provided. As a result, electrode peeling is effectively further prevented.

Thus, by forming a solder fillet not only on the side surface folded portion but also on the end surface portion and in the gap, it is possible to effectively prevent electrode peeling. By so doing, a desired bonding strength is ensured, and it is possible to obtain an electronic component having a highly reliable electrical connection at a low cost.

In addition, the electronic component is inclined with respect to the first and second lead wires. Even when the length of each of the side surface folded portions is relatively short, it is possible to form a sufficient solder fillet. By so doing, even with a small chip electronic component, it is possible to ensure sufficient bonding strength, and, therefore, it is possible to obtain a highly reliable electrical connection. In addition, as compared to where the electronic component is arranged parallel to the first and second lead wires, the electronic component may be disposed in a compact space.

In addition, the first and second metal wire exposed portions are bent to form an L-shape with respect to the corresponding coated portions. Thus, the first and second metal wire exposed portions attached to the side surface folded portions so as to be parallel or substantially parallel to the width direction of the end surface portions of the terminal electrodes. Therefore, it is possible to provide a sufficient solder fillet from the side surface folded portions to the end surface portions. By so doing, even with a small chip electronic component, it is possible to ensure sufficient bonding strength, and, therefore, it is possible to obtain a highly reliable electrical connection.

In addition, surfaces of the first and second metal wire exposed portions are roughened. Thus, even when the first and second metal wire exposed portions are precoated with solder, the solder may be easily adhered to the surfaces of the first and second metal wire exposed portions without falling off. Therefore, it is possible to ensure a sufficient amount of solder provided on the first and second metal wire exposed portions, and, therefore, it is possible to obtain a desired bonding strength.

In addition, each of the first and second metal wire exposed portions has any one of a through-hole, a closed-end hole, a cutout portion, a protrusion, a sawtooth portion, a curved portion, a dish portion, or a combination of any two or more of these, for example. Thus, even when the first and second metal wire exposed portions are precoated with solder, it is possible to ensure a sufficient amount of solder provided on the first and second metal wire exposed portions, and, therefore, it is possible to obtain a desired bonding strength.

In addition, because the electronic component is a surface mount thermistor, it is possible to increase a distance between the terminal electrodes as compared to a plate thermistor. Thus, a solder bridge or an electrochemical migration does not occur, and it is possible to prevent a short-circuit between the terminal electrodes. By so doing, when the thermistor is not outer-coated with the insulating member, it is possible to use a small electronic component, which has sufficient stability and is highly reliable with a simple structure.

In addition, the electronic component includes an internal electrode. Thus, even when peeling occurs, for example, between the terminal electrodes and the component body, the internal electrode primarily determines the characteristics of the electronic component. Thus, the influence on the characteristics of the electronic component is significantly less than that on the characteristics of the single-plate electronic component.

Furthermore, a surface of the electronic component is coated with a glass layer. Thus, moisture resistance is further improved, and therefore, it is possible to obtain high reliability.

In addition, the first lead wire and the second lead wire are integrally bonded to each other in a longitudinal direction thereof to define a parallel lead wire set. Thus, no stress causing separation of the terminal electrodes and the first and second lead wires is applied at bonding portions therebetween. Thus, it is possible to obtain an electronic component having further improved reliability, and, in addition, the usability is improved when long lead wires are used.

Other features, elements, steps, characteristics and advantages of the present invention will become more apparent from the following detailed description of preferred embodiments of the present invention (with reference to the attached drawings).

### BRIEF DESCRIPTION OF THE DRAWINGS

FIG. 1 is a front view showing a preferred embodiment of a surface mount thermistor used in an electronic component according to the present invention.

FIG. 2 is a cross-sectional view of FIG. 1.

FIG. 3 is a cross-sectional view showing a preferred embodiment of a monolithic thermistor, which defines the surface mount thermistor according to the present invention.

FIG. 4 is a front view, with partial cutaway, showing a preferred embodiment of the surface mount thermistor with lead wire, which defines the electronic component with lead wire according to the present invention.

FIG. 5A and FIG. 5B are relevant cross-sectional views of a first lead wire.

FIG. 6A and FIG. 6B are views showing a state in which first and second lead wires are attached to the surface mount thermistor.

FIG. 7A to FIG. 7F are manufacturing process drawings showing a preferred embodiment of a method of manufacturing the thermistor with lead wire according to the present invention.

FIG. 8 is a front view showing an example of a thermistor with lead wire when a parallel lead wire is provided.

FIG. 9A and FIG. 9B are views showing a second preferred embodiment of a thermistor with lead wire according to the present invention.

FIG. 10A and FIG. 10B are views showing a third preferred embodiment of a thermistor with lead wire according to the present invention.

FIG. 11A and FIG. 11B are views showing a fourth preferred embodiment of a thermistor with lead wire according to the present invention.

FIG. 12A to FIG. 12E are views showing alternative examples of a lead wire.

FIG. 13A to FIG. 13D are views showing alternative examples of a lead wire.

FIG. 14 is a cross-sectional view of a thermistor with lead wire described in Japanese Unexamined Patent Application Publication No. 10-149903.

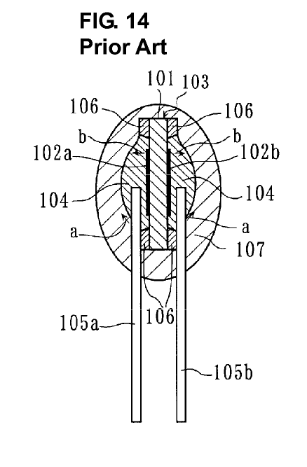

FIG. 15 is a cross-sectional view of a thermistor with lead wire described in Japanese Unexamined Patent Application Publication No. 11-108771.

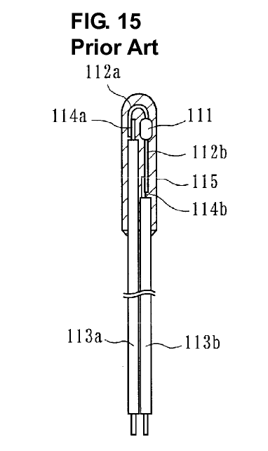

### DETAILED DESCRIPTION OF PREFERRED EMBODIMENTS

Next, preferred embodiments of the present invention will be described with reference to the accompanying drawings.

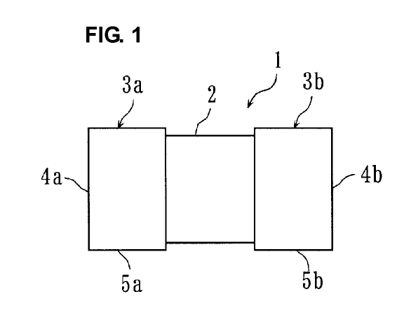

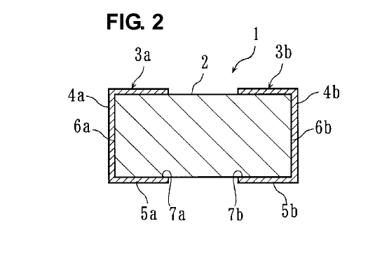

FIG. 1 is a front view showing a preferred embodiment of a surface mount thermistor used in an electronic component with lead wire according to the present invention. FIG. 2 is a cross-sectional view of the present preferred embodiment of the surface mount thermistor.

As shown in FIG. 1 and FIG. 2, the thermistor 1 includes a thermistor body 2 and terminal electrodes 3a and 3b. The thermistor body 2 includes a ceramic material as a main component and preferably has a substantially rectangular parallelepiped shape, for example. The terminal electrodes 3a and 3b are preferably made of a conductive material, such as Ag, Cu, Ni, and Sn, for example, and are formed at both end portions of the thermistor body 2 by baking, for example.

The terminal electrodes 3a and 3b include end surface portions 4a and 4b and side surface folded portions 5a and 5b. As shown in FIG. 2, the terminal electrodes 3a and 3b are arranged so as to cover end surfaces 6a and 6b of the thermistor body 2 and four side surfaces of the thermistor body 2.

With the surface mount thermistor 1, as compared to a single-plate thermistor in which electrode layers are provided on both principal surfaces of a plate-shaped thermistor body as described in Japanese Unexamined Patent Application Publication No. 10-149903, it is possible to increase a distance between the terminal electrodes 3a and 3b. Thus, electrochemical migration does not occur, and a short-circuit between the terminal electrodes is effectively prevented.

In addition, as described above, the thermistor 1 is configured so that the terminal electrodes 3a and 3b cover the end surfaces 6a and 6b of the thermistor body 2. In this case, the end surface portions 4a and 4b are fixedly bonded to the thermistor body 2. Thus, solder fillets are provided not only on the side surface folded portions 5a and 5b but also on the end surface portions 4a and 4b, so as to further prevent electrode peeling. In addition, the influence on a resistance value is relatively small when electrode peeling occurs. That is, in the surface mount thermistor 1, the side surface folded portions 5a and 5b influence the resistance value to a greater extent than the end surface portions 4a and 4b. Thus, the influence of peeling of the terminal electrodes 3a and 3b from the thermistor body 2 on the resistance value is relatively small.

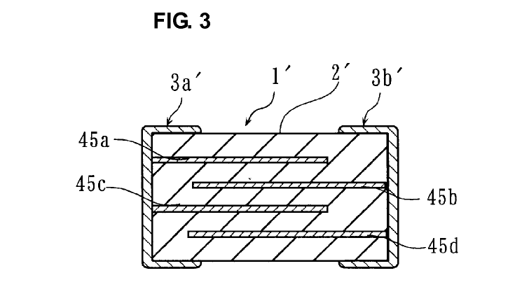

In addition, the surface mount thermistor of this type may preferably utilize a monolithic thermistor 1′ as shown in FIG. 3. That is the thermistor 1′ includes internal electrodes 45a to 45d inside the thermistor body 2′. The internal electrodes 45a to 45d are arranged parallel or substantially parallel to one another in a laminated direction. Then, the internal electrodes 45a and 45c are electrically connected to a terminal electrode 3a′, and the internal electrodes 45b and 45d are electrically connected to a terminal electrode 3b′. In the monolithic thermistor 1′, the internal electrodes 45a to 45d primarily influence the resistance value. Thus, even when peeling occurs between the terminal electrodes 3a′ and 3b′ and the thermistor body 2′, the influence of the peeling on the resistance value of the thermistor 1′ is significantly less than that on the plate-shaped thermistor.

In addition, the surface mount thermistors 1 and 1′ are designed to withstand usage in an external environment, so the surface mount thermistors 1 and 1′ are highly reliable and resistant to the environment. Thus, there is very little influence on the thermistors 1 and 1′ when lead wires are attached, and adjustment and selection of the characteristics of the thermistor element after the lead wires are attached may be simplified.

The surface mount thermistors 1 and 1′ may preferably include a chip thermistor having outer dimensions of, for example, a length of about 1.0 mm, a width of about 0.5 mm and a thickness of about 0.5 mm, or a length of about 0.6 mm, a width of about 0.3 mm and a thickness of about 0.3 mm.

In the following preferred embodiment, a thermistor that does not include the internal electrodes 45a to 45d will be described as a typical example of the electronic component.

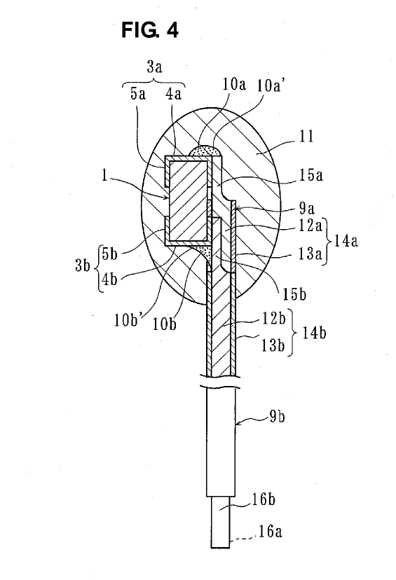

FIG. 4 is a front view, with partial cutaway, showing a preferred embodiment of a thermistor with lead wire according to the present invention.

In the thermistor with lead wire, long first and second lead wires 9a and 9b are connected to the thermistor 1 via solders 10a and 10b, and distal end regions of the first and second lead wires 9a and 9b, the thermistor 1, and the solders 10a and 10b are outer-coated with an insulating member 11.

The first and second lead wires 9a and 9b include coated portions 14a and 14b and first and second metal wire exposed portions 15a and 15b. The coated portions 14a and 14b are configured so that metal wires 12a and 12b are coated with insulating members 13a and 13b. In the first and second metal wire exposed portions 15a and 15b, the insulating members 13a and 13b are removed.

In addition, the first lead wire 9a and the second lead wire 9b are arranged parallel or substantially parallel to each other. The second lead wire 9b is shorter than the first lead wire 9a.

Then, the first metal wire exposed portion 15a is bonded to the side surface folded portion 5a of the one terminal electrode 3a via solder 10a, and the second metal wire exposed portion 15b is bonded to the side surface folded portion 5b of the other terminal electrode 3b via solder 10b.

In addition, the insulating members 13a and 13b are removed from terminal portions 16a and 16b of the lead wires 9a and 9b, and the terminal portions 16a and 16b are coated with solder.

Hereinafter, the structure of the thermistor with lead wire will be further specifically described.

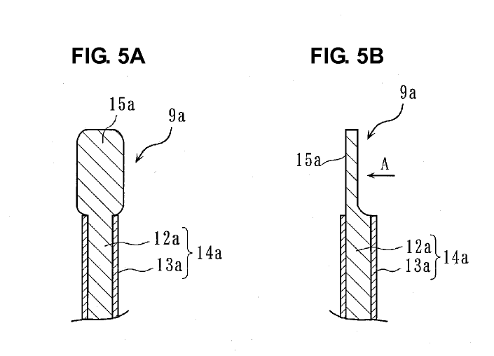

FIG. 5A and FIG. 5B are relevant cross-sectional views of the first lead wire 9a. Note that, in the present preferred embodiment, the first lead wire 9a will be described with reference to the drawings, and the second lead wire 9b is substantially similar to the first lead wire 9a.

The first lead wire 9a includes the coated portion 14a and the first metal wire exposed portion 15a, as described above. Then, in the coated portion 14a, the metal wire 12a is coated with the insulating member 13a. In the first metal wire exposed portion 15a, the insulating member 13a is removed from the metal wire 12a, and the metal wire 12a is exposed.

Here, the metal wire 12a is preferably copper, for example, having favorable wettability. However, material used for the metal wire 12a is not specifically limited as long as it can be bonded by solder. The metal wire 12a may preferably be iron, nickel, alloys of them, or composite materials of thereof, for example. In addition, the insulating member 13a is not specifically limited as long as it is heat resistant and can withstand reflow soldering. The insulating member 13a may be urethane resin, acrylic resin, and fluororesin, for example.

Then, the first metal wire exposed portion 15a is flattened by hot pressing from one direction (indicated by the arrow A in FIG. 5B) so as to have a wide flat shape to increase a contact area with the solder 10a.

By flattening the first metal wire exposed portion 15a, a contact area with the side surface folded portion 5a to be soldered is increased, and improved thermal conductivity is obtained by heating the first metal wire exposed portion 15a during bonding. Thus, the electrical connection between the first lead wire 9a and the terminal electrode 3a is improved. In addition, because improved thermal conductivity is obtained, the temperature of a heater can preferably be decreased, and therefore, damage to the thermistor 1 is prevented.

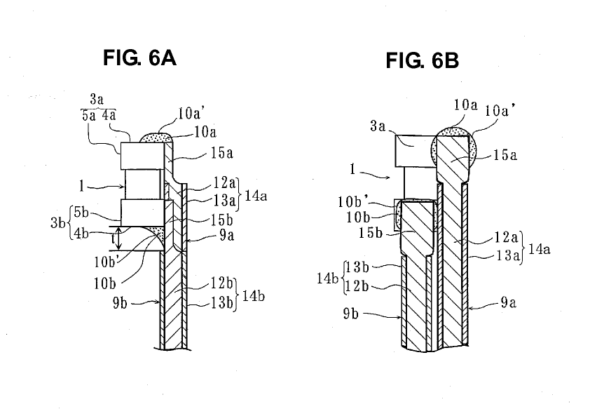

FIG. 6A and FIG. 6B are views showing a state in which the lead wires 9a and 9b are attached to the thermistor 1. FIG. 6A is a front view, and FIG. 6B is a right side view.

That is, the first lead wire 9a and the second lead wire 9b are arranged parallel or substantially parallel to each other, and the second lead wire 9b is shorter than the first lead wire 9b.

Then, the first and second lead wires 9a and 9b are arranged so that the side surface folded portion 5a of the terminal electrode 3a, connected to the first metal wire exposed portion 15a, and the side surface folded portion 5b of the terminal electrode 3b, connected to the second metal wire exposed portion 15b, are located substantially in the same plane. That is, the first metal wire exposed portion 15a is bonded to the side surface folded portion 5a of the one terminal electrode 3a via the solder 10a, and the second metal wire exposed portion 15b is bonded to the side surface folded portion 5a of the other terminal electrode 3b via the solder 10b.

Then, a solder fillet 10a′ is formed on the side surface folded portion 5a and the end surface portion 4a of the terminal electrode 3a.

That is, as described above, the end surface portions 4a and 4b are more firmly bonded to the thermistor body 2 than the side surface folded portions 5a and 5b. Thus, by forming a solder fillet not only on the side surface folded portion 5a but also on the end surface portion 4a, it is possible to effectively prevent electrode peeling. Thus, the bonding strength is improved, and the reliability of the electrical connection is further improved.

In addition, the second metal wire exposed portion 15b is configured to have a gap t between the distal end of the coated portion 14b and the end surface portion 4b of the terminal electrode 3b, and a solder fillet 10b′ is formed on the side surface folded portion 5b and end surface portion 4b of the terminal electrode 3b and in the gap t. With this configuration, the region in which the solder fillet 10b′ is formed is advantageously increased. As a result, with the formation of the solder fillet 10b′ on the end surface portion 4b, electrode peeling is more effectively prevented. Thus, the bonding strength is further improved, and the reliability of the electrical connection is further improved.

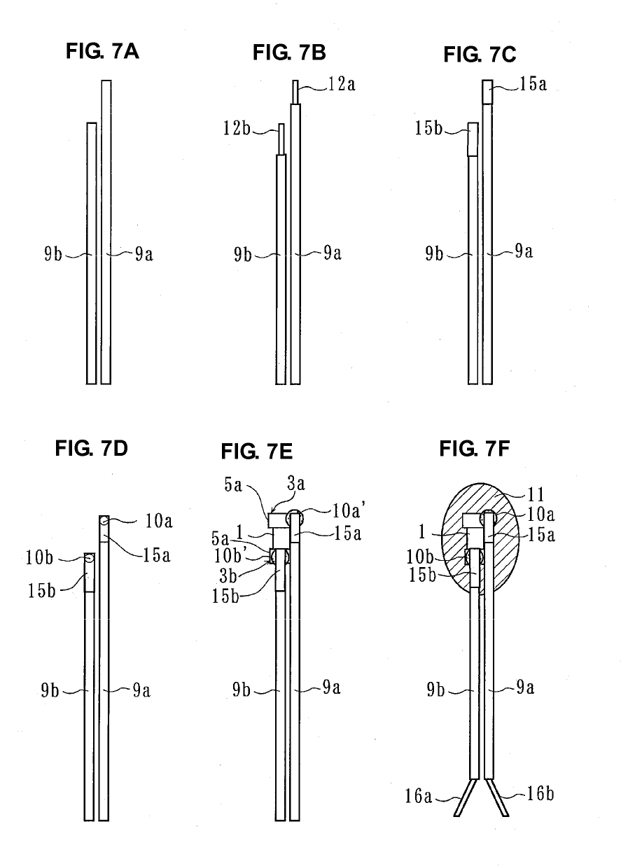

FIG. 7A to FIG. 7F are manufacturing process drawings that show a method of manufacturing the thermistor with lead wire.

First, as shown in FIG. 7A, the first and second lead wires 9a and 9b that are cut to predetermined sizes with different lengths are prepared. Subsequently, as shown in FIG. 7B, the insulating members of the distal end portions of the first and second lead wires 9a and 9b are removed to expose the surfaces of the metal wires 12a and 12b. In this case, the insulating member removed from the second lead wire 9b is slightly larger than that of the first lead wire 9a so that the gap t may be ensured between the end surface portion and the coated portion when the thermistor is attached. The metal wires 12a and 12b are pressed in one direction while being heated as required to form the wide flat shape. Thus, as shown in FIG. 7C, the flat first and second metal wire exposed portions 15a and 15b are formed.

Next, as shown in FIG. 7D, the first and second metal wire exposed portions 15a and 15b are precoated with the solders 10a and 10b.

The solder precoating may preferably be performed so that only the distal end portions of the first and second lead wires 9a and 9b are immersed in molten solder or solder paste is applied to the distal end portions of the first and second lead wires 9a and 9b, and then the solder is heated to melt and expand to wet the first and second metal wire exposed portions 15a and 15b.

Subsequently, as shown in FIG. 7E, the thermistor 1 is arranged so that the side surface folded portion 5a of the terminal electrode 3a is in contact with the first metal wire exposed portion 15a via the precoated solder 10a, and the side surface folded portion 5b of the terminal electrode 3b is in contact with the second metal wire exposed portion 15b via the precoated solder 10b.

Then, the solder is heated to melt and bond the terminal electrodes 3a and 3b of the thermistor 1 to the first and second metal wire exposed portions 15a and 15b at the side surface folded portions 5a and 5b. Note that, in this case, by heating the thermistor 1 while being pressed against the first lead wire 9a, it is possible to obtain a thermistor with lead wire that has outstanding bonding.

Next, as shown in FIG. 7F, the insulating member 11 is applied so as to coat the first and second lead wires 9a and 9b, the solders 10a and 10b, and the thermistor 1, and is cured at a predetermined temperature (for example, about 150° C.) for a predetermined period of time (for example, about 1 hour). Thereafter, the component is immersed in a solder bath of a predetermined temperature (for example, about 360° C.) so as to peel off insulating members 14a and 14b from the lower ends of the first and second lead wires 9a and 9b in predetermined length (for example, about 5 mm) to form the terminal portions 16a and 16b, and then the terminal portions 16a and 16b are coated with solder. Thus, the thermistor with lead wire as shown in FIG. 4 is manufactured.

In this manner, according to the first preferred embodiment, because the first and second metal wire exposed portions 15a and 15b have a flat shape, respective contact areas between the metal wires 12a and 12b and the side surface folded portions 5a and 5b are increased. Thus, as described above, by heating the first and second metal wire exposed portions 15a and 15b at the time of bonding, thermal conductivity is improved, and, therefore, the reliability of the electrical connection between the first and second lead wires 9a and 9b and the terminal electrodes 3a and 3b is improved. Furthermore, because thermal conductivity is improved, the temperature of a heater may be decreased. Thus, damage to the thermistor 1 is prevented.

Then, the first and second lead wires 9a and 9b are arranged so that the side surface folded portion 5a of the terminal electrode 3a, to which the first metal wire exposed portion 15a is bonded, and the side surface folded portion 5b of the terminal electrode 3b, to which the second metal wire exposed portion 15b is bonded, are arranged substantially in the same plane. Thus, even when a force is applied in directions forcing the first lead wire 9a and the second lead wire 9b away from each other, those directions differ from the direction in which the first lead wire 9a and the second lead wire 9b peel off from the terminal electrodes 3a and 3b. Thus, the first and second lead wires 9a and 9b are prevented from peeling off from the terminal electrodes 3a and 3b. That is, the bonding strength between the first and second lead wires 9a and 9b and the terminal electrodes 3a and 3b is improved at a low cost and with a simple structure. Therefore, a highly reliable electrical connection is provided.

In addition, because the solder fillet 10a′ is formed on the side surface folded portion 5a and the end surface portion 4b of the terminal electrode 3a, electrode peeling is effectively prevented. Thus, the bonding strength is improved even with a small thermistor with lead wire, and, therefore, a thermistor with lead wire having a highly reliable electrical connection is obtained.

Furthermore, the second metal wire exposed portion 15b is configured so as to have the gap t between the coated portion 14b and the end surface portion 4b of the terminal electrode 3b, and the solder fillet 10b′ is formed on the side surface folded portion 5b, on end surface portion 4b of the terminal electrode 3b, and in the gap t. Thus, the region in which the solder fillet 10b′ is formed is increased. Thus, with the formation of the solder fillet 10b′ on the end surface portion 4b, electrode peeling is even more effectively prevented. Thus, the bonding strength is further improved, and the reliability of the electrical connection is further improved.

Note that, in the first preferred embodiment, the thermistor 1 is outer-coated with the insulating member 11. However, even when the thermistor is not outer-coated with the insulating member 11, it is possible to suppress the influence of a stress applied to the first and second lead wires 9a and 9b, an impact from the outside, and other external forces. Thus, the thermistor with lead wire will have outstanding sensitivity.

In addition, the thermistor 1 is securely fixed by the first and second lead wires 9a and 9b. Thus, even when the thermistor 1 is outer-coated with the insulating member 11 in order to improve environmental resistance, the influence of thermal expansion of the insulating member 11 is effectively prevented.

In addition, in the manufacturing method described above, before the thermistor 1 is set, the first and second lead wires 9a and 9b are precoated with solder, and then the thermistor 1 is soldered to the first and second lead wires 9a and 9b. Thus, a temperature sensor with lead wire which has outstanding mass productivity and is suitable for miniaturization of the thermistor 1 is obtained.

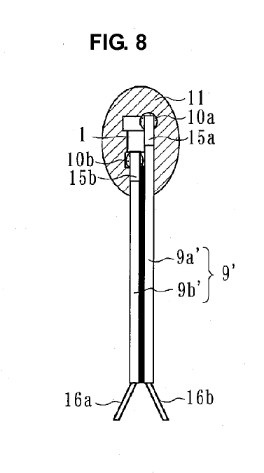

FIG. 8 is a front view of an example of a thermistor with lead wire which includes a parallel lead wire 9′. The parallel lead wire 9′ is configured such that first and second lead wires 9a′ and 9b′ are integrally bonded to each other in the longitudinal direction.

With the parallel lead wire 9′, no separating force is applied to the bonding portions of the terminal electrodes 3a and 3b and the first and second lead wires 9a′ and 9b′. Thus, a highly reliable thermistor with lead wire is provided.

In addition, the thermistor with lead wire shown in FIG. 4 includes the first lead wire 9a and the second lead wire 9b that are separated from each other. Therefore, when a long lead wire is used, there is a possibility that the usability may be poor as a set. Thus, particularly if a long lead wire is used, it is preferable to use the preferred embodiment shown in FIG. 8.

Note that the structure and manufacturing method of the thermistor with lead wire shown in FIG. 8 are similar to those shown in FIG. 4 to FIG. 7F, and thus, the description thereof is omitted.

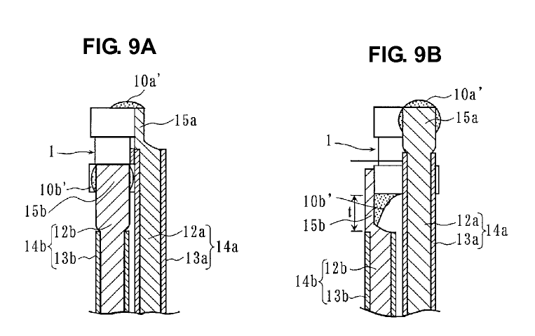

FIG. 9A and FIG. 9B are views showing a relevant portion of a second preferred embodiment of a thermistor with lead wire according to the present invention. FIG. 9A is a front view, and FIG. 9B is a right side view.

In the second preferred embodiment, the side surface folded portion 5a to which the first metal wire exposed portion 15a is bonded and the side surface folded portion 5b to which the first metal wire exposed portion 15b is bonded are not arranged substantially in the same plane, which is different from the first preferred embodiment. The first and second lead wires 9a and 9b are arranged so that the respective surfaces of the side surface folded portion 5a and side surface folded portion 5b are arranged substantially vertically with respect to each other.

Then, in the second preferred embodiment, even when force is applied in directions forcing the first lead wire 9a and the second lead wire 9b away from each other, those directions are different from the directions in which the first and second lead wires 9a and 9b peel off from the terminal electrodes 3a and 3b. Thus, the first and second lead wires 9a and 9b are prevented from peeling off from the terminal electrodes 3a and 3b. That is, the bonding strength between the first and second lead wires 9a and 9b and the terminal electrodes 3a and 3b is improved at a low cost and with a simple structure. Therefore, a highly reliable electrical connection is provided.

In addition, as in the first preferred embodiment, because the first and second metal wire exposed portions 15a and 15b have a flat shape, contact areas between the metal wires 12a and 12b and the side surface folded portions 5a and 5b are increased. Thus, by heating the first and second metal wire exposed portions 15a and 15b at the time of bonding, thermal conductivity is improved, and the reliability of the electrical connection between the first and second lead wires 9a and 9b and the terminal electrodes 3a and 3b is improved. In addition, due to the improved thermal conductivity, the temperature of a heater can be decreased such that damage to the thermistor 1 is prevented.

In addition, because the solder fillet 10a′ is formed on the side surface folded portion 5a and the end surface portion 4b of the terminal electrode 3a, electrode peeling is effectively prevented. Furthermore, the second metal wire exposed portion 15b is configured to have the gap t between the coated portion 14b and the end surface portion 4b of the terminal electrode 3b, and the solder fillet 10b′ is formed on the side surface folded portion 5b, on the end surface portion 4b of the terminal electrode 3b, and in the gap t. Thus, the region in which the solder fillet 10b′ is formed is increased. Thus, electrode peeling is even more effectively prevented.

With this configuration, even with a small chip electronic component, sufficient bonding strength is ensured, and the reliability of the electrical connection is further improved.

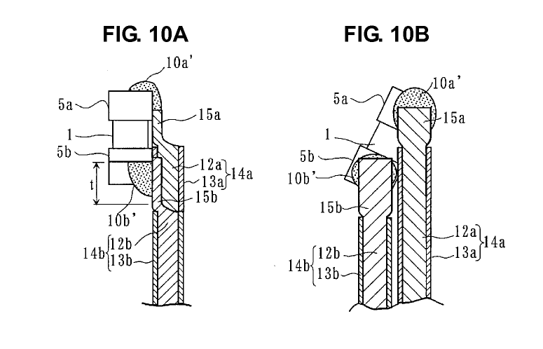

FIG. 10A and FIG. 10B are views showing a relevant portion of a third preferred embodiment of a thermistor with lead wire according to the present invention. FIG. 10A is a front view, and FIG. 10B is a right side view.

In the third preferred embodiment, the first and second lead wires 9a and 9b are arranged so that the side surface folded portions 5a and 5b bonded to the first and second metal wire exposed portions 15a and 15b are located substantially in the same plane, and the thermistor 1 is arranged so that these side surface folded portions 5a and 5b are inclined with respect to the longitudinal direction of the first and second lead wires 9a and 9b.

In the first preferred embodiment, when the lengths of sides of the side surface folded portions 5a and 5b which contact the first and second metal wire exposed portions 15a and 15b are relatively short, the region in which a solder fillet is formed is relatively narrow and therefore, it is difficult to obtain sufficient bonding strength.

In the third preferred embodiment, the thermistor 1 is arranged so that the side surface folded portions 5a and 5b are inclined with respect to the longitudinal direction of the first and second lead wires 9a and 9b. With this arrangement, sufficient solder fillets 10a′ and 10b′ can be formed on the side surface folded portion 5a and end surface portion 4a of the terminal electrode 3a, on the side surface folded portion 5b and end surface portion 4b of the terminal electrode 3b, and in the gap t. Thus, even with an extremely small thermistor having short lengths of the sides of the side surface folded portions 5a and 5b, sufficient bonding strength is ensured, and therefore, a highly reliable electrical connection is provided.

In addition, by inclining the thermistor 1 with respect to the first and second lead wires 9a and 9b, as compared to the case in which the thermistor 1 is arranged parallel or substantially parallel to the first and second lead wires 9a and 9b, the thermistor 1 may be disposed in a compact space.

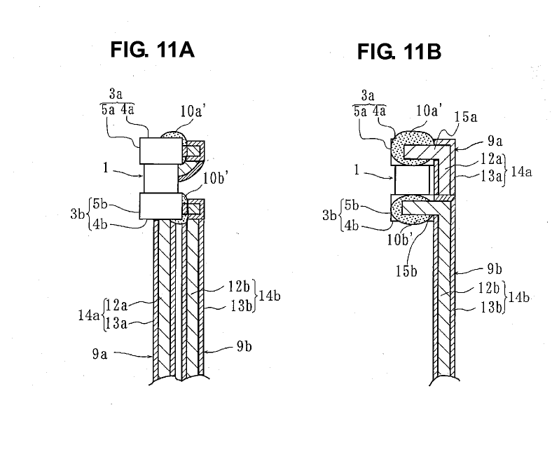

FIG. 11A and FIG. 11B are views showing a relevant portion of a fourth preferred embodiment of a thermistor with lead wire according to the present invention. FIG. 11A is a front view, and FIG. 11B is a right side view.

In the fourth preferred embodiment, the first and second metal wire exposed portions 15a and 15b are bent to have an L-shape with respect to the coated portions 14a and 14b.

That is, the distal end portion of the first lead wire 9a is bent to have an L-shape so that the coated portion 14a is arranged along the end surface portion 4a of the terminal electrode 3a, and further extended to have an L-shape with respect to the coated portion 14a so that the first metal wire exposed portion 15a is located on the side surface folded portion 5a. In addition, the distal end portion of the second lead wire 9b is bent to have an L-shape with respect to the coated portion 14b so that the second metal wire exposed portion 15b is located on the side surface folded portion 5b.

In the fourth preferred embodiment, the first and second metal wire exposed portions 15a and 15b are bent to have an L-shape with respect to the coated portions 14a and 14b. Thus, the first and second metal wire exposed portions 15a and 15b are attached to the side surface folded portions 5a and 5b so as to be parallel or substantially parallel to the width direction of the end surface portions 4a and 4b of the terminal electrodes 3a and 3b. Thus, even with a small thermistor, sufficient solder fillets 10a′ and 10b′ may be formed on the side surface folded portions 5a and 5b, on the end surface portions 4a and 4b, and in the gap. With this configuration, sufficient bonding strength is ensured, and therefore, a highly reliable electrical connection is provided.

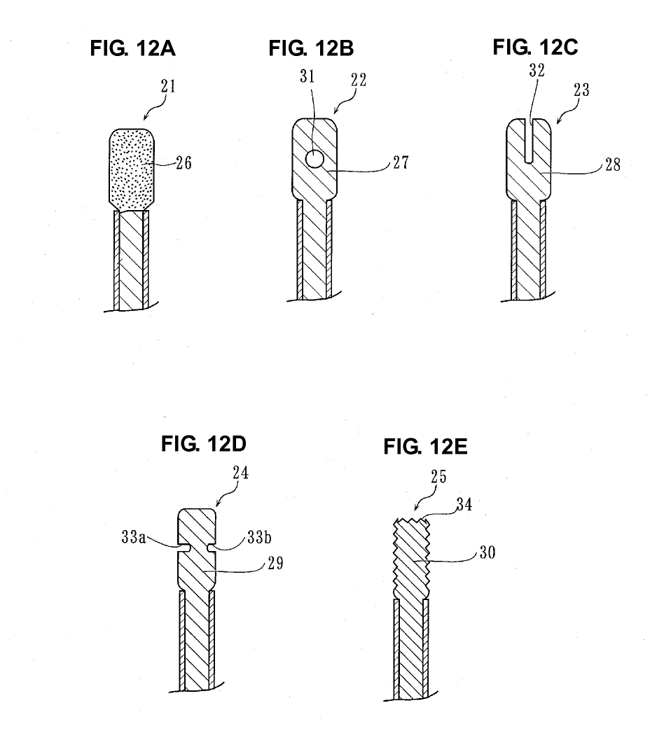

FIG. 12A to FIG. 12E show various alternative preferred embodiments of the surface shape of a metal wire exposed portion of a lead wire (first and second lead wires).

That is, in lead wires 21 to 25 shown in FIG. 12A to FIG. 12E, all metal wire exposed portions 26 to 30 have a wide flat shape, as is substantially similar to FIG. 5A and FIG. 5B.

In the lead wire 21 shown in FIG. 12A, the surface of the metal wire exposed portion 26 is subjected to surface roughening, such as sand blasting or etching, for example. In the lead wire 22 shown in FIG. 12B, the metal wire exposed portion 27 has a through-hole 31 provided therein. Note that in FIG. 12B, the through-hole 31 is provided, however, it may be modified to a hole with a closed end. In the lead wire 23 shown in FIG. 12C, a groove-shaped cutout portion 32 is provided at the distal end of the metal wire exposed portion 28. In the lead wire 24 shown in FIG. 12D, groove-like cutout portions 33a and 33b are provided at left and right edges of the metal wire exposed portion 29. In the lead wire 25 shown in FIG. 12E, a periphery 34 of the metal wire exposed portion 30 has a sawtooth shape.

In this manner, the surfaces of the metal wire exposed portions 26 to 30 have shapes on which solder is more easily adhered. Thus, the amount of solder adhered to the metal wire exposed portions 26 to 30 is increased, which improves the bonding strength.

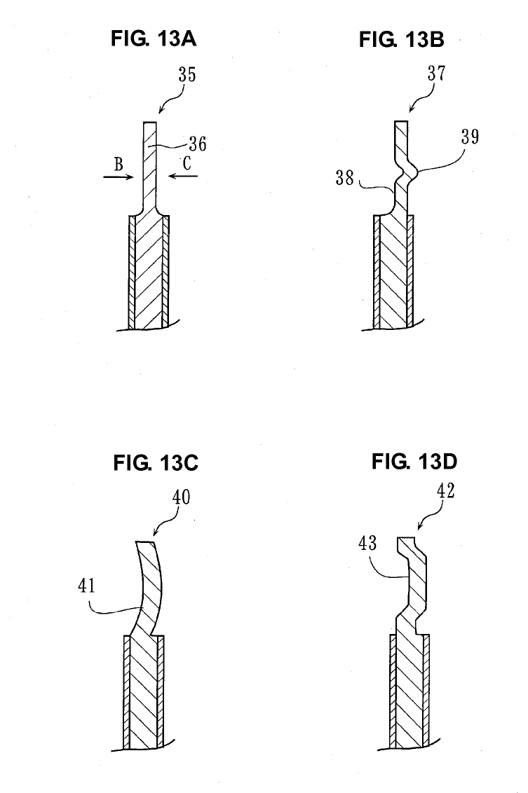

FIG. 13A to FIG. 13D show various alternative preferred embodiments of the cross-sectional shape of a metal wire exposed portion of a lead wire (first and second lead wires).

In a lead wire 35 shown in FIG. 13A, a metal wire exposed portion 36 is flattened by a pressing force from both directions (indicated by the arrow B and the arrow C in the drawing), so as to have a wide, flat shape.

In this manner, it is only necessary that the metal wire exposed portion 36 has a shape such that the contact area of the metal wire exposed portion 36 to be soldered on the side surface folded portion is increased. Thus, the metal wire exposed portion 36 may be pressed from both directions so as to have a flat shape. Note that the metal wire exposed portion 36 may be heated as required during pressing. By pressing the metal wire exposed portion 36 while being heated, it is easy to form a flat metal wire exposed portion.

In a lead wire 37 shown in FIG. 13B, a protrusion 39 is provided at an appropriate portion on the surface of the metal wire exposed portion 38. Note that FIG. 13B shows only one protrusion 39, however, two or more protrusions may be provided. In a lead wire 40 shown in FIG. 13C, an inner surface of a metal wire exposed portion 41 is curved in a concave shape to define a curved portion. In addition, in a lead wire 42 shown in FIG. 13D, an internal surface of a metal wire exposed portion 43 has a dish shape to define a dish portion.

As in FIG. 13B to FIG. 13D, by configuring the metal wire exposed portion so as to have a substantially flat cross-sectional shape so that solder easily accumulates in the metal wire exposed portion, the amount of solder adhered thereto in increased such that the bonding strength is improved.

Note that preferred embodiments of the present invention are not limited to the above-described preferred embodiments. In the first preferred embodiment, the thermistor with lead wire is manufactured such that the metal wire is preferably exposed portions 15a and 15b are precoated with solder. Instead, it may be manufactured such that solder paste is applied to the metal wire exposed portions 15a and 15b. In this case, solder paste made of Sn—Ag—Cn, for example, is preferably applied to the side surface folded portions 5a and 5b of the terminal electrodes 3a and 3b and the metal wire exposed portions 15a and 15b. After that, a heater, for example, is used to heat the solder paste at a predetermined temperature (for example, about 240° C.) for a predetermined period of time (for example, about 5 hours) to melt. Thus, the first and second metal wire exposed portions 15a and 15b may be easily bonded to the side surface folded portions 5a and 5b.

In addition, in the above-described preferred embodiments, the thermistor is preferably used as an example of the electronic component. The thermistor may be any one of a positive characteristic thermistor and a negative characteristic thermistor, for example. In addition, the electronic component is not limited to the thermistor, and preferred embodiments of the present invention may be applied to another electronic component, for example, a monolithic ceramic capacitor.

In addition, according to preferred embodiments of the invention, it is advantageous in that it is not necessary to outer-coat an electronic component with an insulating member as in the related art, and, therefore, it is possible to obtain an electronic component, such as a thermistor, having improved sensitivity. However, as described in the first preferred embodiment, outer-coating with the insulating member 11 is not prohibited. With the outer-coated insulated member 11, moisture resistance is further improved, and therefore, high reliability can be obtained. In this case, the insulating member 11 may preferably be epoxy resin, acrylic resin, urethane resin, silicon resin, ethylene resin, for example.

While preferred embodiments of the present invention have been described above, it is to be understood that variations and modifications will be apparent to those skilled in the art without departing the scope and spirit of the invention. The scope of the present invention, therefore, is to be determined solely by the following claims.

What is claimed is:

1. An electronic component comprising:
an electronic component including a component body and terminal electrodes, each of the terminal electrodes having an end surface portion and a side surface folded portion and being disposed on side surfaces of the component body; and
first and second lead wires electrically connected to the terminal electrodes; wherein
each of the first and second lead wires includes a coated portion in which a metal wire is coated with an insulating member, and first and second metal wire exposed portions having a flat shape or a substantially flat shape and being electrically connected to the terminal electrodes;
the first lead wire and the second lead wire are arranged parallel or substantially parallel to each other, and the second lead wire is shorter than the first lead wire; and
the first metal wire exposed portion is bonded to the side surface folded portion of one of the terminal electrodes via solder, and the second metal wire exposed portion is bonded to the side surface folded portion of another one of the terminal electrodes via solder.

2. The electronic component with lead wire according to claim 1, wherein the first and second lead wires are arranged so that the side surface folded portion of the one of the terminal electrodes to which the first metal wire exposed portion is bonded and the side surface folded portion of the another one of the terminal electrodes to which the second metal wire exposed portion is bonded are arranged substantially in the same plane.

3. The electronic component with lead wire according to claim 1, wherein the first and second lead wires are arranged so that a surface of the side surface folded portion of the one of the terminal electrodes to which the first metal wire exposed portion is bonded and a surface of the side surface folded portion of the another one of the terminal electrodes to which the second metal wire exposed portion is bonded are arranged substantially vertically with respect to each other.

4. The electronic component with lead wire according to claim 1, wherein a solder fillet is provided on the side surface folded portion and the end surface portion of the one of the terminal electrodes.

5. The electronic component with lead wire according to claim 1, wherein the second metal wire exposed portion is arranged to have a gap between a distal end of the coated portion and the end surface portion of the another one of the terminal electrodes, and a solder fillet is provided on the side surface folded portion, one the end surface portion of the another one of the terminal electrodes, and in the gap.

6. The electronic component with lead wire according to claim 1, wherein the electronic component is inclined with respect to the first and second lead wires.

7. The electronic component with lead wire according to claim 1, wherein the first and second metal wire exposed portions are bent to have an L-shape with respect to the coated portions thereof.

8. The electronic component with lead wire according to claim 1, wherein surfaces of the first and second metal wire exposed portions are roughened.

9. The electronic component with lead wire according to claim 1, wherein each of the first and second metal wire exposed portions include at least one of a through-hole, a closed-end hole, a cutout portion, a protrusion, a sawtooth portion, a curved portion, and a dish portion.

10. The electronic component with lead wire according to claim 1, wherein the electronic component is a surface mount thermistor.

11. The electronic component with lead wire according to claim 1, wherein the electronic component includes an internal electrode.

12. The electronic component with lead wire according to claim 1, wherein a surface of the electronic component is coated with a glass layer.

13. The electronic component with lead wire according to claim 1, wherein the first lead wire and the second lead wire are integrally bonded to each other in a longitudinal direction thereof to define a parallel lead wire set.
